(19) United States
(12) Patent Application Publication
(10) Pub. No.: US 2012/0096393 A1
(43) Pub. Date: Apr. 19, 2012

(54) METHOD AND APPARATUS FOR CONTROLLING TOUCH SCREEN IN MOBILE TERMINAL RESPONSIVE TO MULTI-TOUCH INPUTS

(75) Inventors: Su Mi SHIM, Gyeonggi-do (KR); Su Jung YOUN, Gyeonggi-do (KR); Kyoung Ae LIM, Seoul (KR); Sang Ki LEE, Seoul (KR); Wan Soo LIM, Gyeonggi-do (KR)

(73) Assignee: SAMSUNG ELECTRONICS CO., LTD., Gyeonggi-Do (KR)

(21) Appl. No.: 13/275,613

(22) Filed: Oct. 18, 2011

(30) Foreign Application Priority Data
Oct. 19, 2010 (KR) 10-2010-0101721

(51) Int. Cl. G06F 3/048

(52) U.S. Cl. 715/784

(57) ABSTRACT

A mobile terminal and method for controlling a touch screen thereof are provided, wherein multi-point touch inputs such as a multi-point sweep input and/or a multi-point double tap input are sensed by a controller, and in response to a multi-point sweep, a display screen can be scrolled at a faster rate relative to a scroll in response to sensing a single point sweep, thus enabling a user to rapidly scroll to desired portions of an information screen using e.g., a two finger sweep, and to scroll slower using a single finger sweep at the same sweep rate and during a photo album application, scrolling to other photos in response to a multi-touch input is possible while in a zoomed-in state, while panning is carried out responsive to a single point touch input.

### CLAIM OF PRIORITY

This application claims priority under 35 U.S.C. §119(a) to a Korean Patent Application filed in the Korean Intellectual Property Office on Oct. 19, 2010 and assigned Serial No. 10-2010-0101721, the contents of which are incorporated herein by reference.

### BACKGROUND OF THE INVENTION

1. Field of the Invention

The present invention relates to controlling touch screen displays in portable electronic devices, and in particular, to controlling touch screen displays in mobile communication terminals.

2. Description of the Related Art

In recent years, the use of mobile terminals has grown rapidly, to the point where they have become a commodity in today's society. The functionality of commonly used mobile terminals has grown from handling voice calls, to data transmission, digital photography and storage, multimedia communication capability, etc. Recently developed touch screen technology has been applied to the mobile terminal such that preference for a touch screen based mobile terminal has gradually increased.

During various operations, the mobile terminal displays an scrollable information screen such as a phone book contact list screen, a browser screen (i.e., a web page), or a digital photo album. More specifically, the mobile terminal typically displays a “display screen” (used herein to refer to an image or content currently displayed) that contains only a portion of the information within an overall scrollable information screen (hereafter, the “information screen”). In other words, a portion of the information screen is typically hidden to the user at any given time. To scroll or “move the display screen”, i.e., to change the current display such that a different portion of the overall information screen is displayed, a user inputs a sweep operation in which touch input, touch location movement, and touch release are continuously effected. When little information is included in the information screen, or when the user desires to view a portion of a large information screen in close proximity to the portion currently displayed, the user may move the current display screen to the different portion of the information screen by using only one or two swing operations. Conversely, when much information is included in the information screen, many swing operations are typically required to move a current display screen to another desired part. Such multiple swing operations may be considered annoying and inconvenience the user.

In a digital photo album application or the like, a user may input a swing operation to sequentially view images, and zoom-in to view enlarged portions of an image if desired. However, to view the next image in the photo album sequence in a zoomed-in state thereof, the user needs to first restore the zoomed-in image to its original size and then input the swing operation. This two-step process may further inconvenience the user.

### SUMMARY OF THE INVENTION

The present invention provides a method for controlling a touch screen in a mobile terminal, affording enhanced functionality with user convenience, by sensing special multi-point touch inputs and carrying out unique scrolling operations in response thereto. Multi-point touch inputs such as a multi-point sweep input and/or a multi-point double tap input are sensed by a controller. In response to a multi-point sweep, a display screen can be scrolled at a faster rate relative to a scroll responsive to sensing a single point sweep. This enables a user to rapidly scroll to desired portions of an information screen using e.g., a two finger sweep, and to scroll slower using a single finger sweep at the same sweep rate.

In another embodiment, a multi-point sweep input at a predetermined region of a display screen or otherwise can be used to instantly scroll the screen to a beginning portion, or to an end portion, of a scrollable information screen. A multi-point double tap input at predetermined regions of the display screen can also be used for this purpose.

In still another embodiment, the distance between a start point and an end point of a multi-point sweep can be used to determine how far a display screen should be scrolled. A ratio between the distance between the beginning and end points of the sweep, and the distance between the beginning point of the sweep and the edge of the screen, can be used to determine the extent of the responsive scroll operation.

Embodiments of the invention can be configured for vertically oriented information screens, such as a web page, and for horizontally oriented information screens such as that of a digital photo album.

In still another embodiment of the invention, a method for controlling a screen in a mobile terminal includes: displaying a scrollable information screen; sensing touch input at two or more points simultaneously on the information screen; and scrolling the information screen in response to at least the sensing of the touch input, at a faster scroll rate than a scroll rate associated with a single point touch input.

In accordance with the invention, a method for controlling a screen in a mobile terminal includes: displaying a display screen that is a portion of a scrollable information screen; sensing at least one of a multi-touch sweep and a multi-touch double tap input; and scrolling the display screen, responsive to at least the sensing, in a manner that is different than a scroll operation responsive to only a single point touch input.

In still another embodiment of the present invention, when executing an image view (e.g., photo album) application, a user may scroll to a subsequent or previous image by one swing operation in a zoomed-in state of images to improve user convenience. When a multi-point sweep on a display screen is sensed in a zoomed-in state of an image, the display screen is scrolled to the next or the previous image in accordance with the direction of the sweep. On the other hand, when a single point sweep is sensed in the zoomed-in state, the image is panned within the currently displayed image. Thus in contrast to the functionality of conventional devices, the user need not perform the additional step of reducing the image from the zoomed-in state, in order to scroll to other images.

### BRIEF DESCRIPTION OF THE DRAWINGS

The above features and advantages of the present invention will be more apparent from the following detailed description in conjunction with the accompanying drawings, in which:

FIG. 1 is a block diagram illustrating a configuration of a mobile terminal according to an exemplary embodiment of the present invention;

FIG. 2 is a flowchart illustrating a method for controlling a screen in a mobile terminal according to a first exemplary embodiment of the present invention;

FIG. 3 is a view illustrating a display screen of a mobile terminal displayed by a method for controlling a screen in a mobile terminal according to a first exemplary embodiment of the present invention;

FIG. 4 is a flowchart illustrating a method for controlling a screen in a mobile terminal according to a second exemplary embodiment of the present invention;

FIG. 5 is a view illustrating a display screen of a mobile terminal displayed by a method for controlling a screen in a mobile terminal according to a second exemplary embodiment of the present invention;

FIG. 6 is a flowchart illustrating a method for controlling a screen in a mobile terminal according to a third exemplary embodiment of the present invention;

FIG. 7 is a view illustrating a display screen of a mobile terminal displayed by a method for controlling a screen in a mobile terminal according to a third exemplary embodiment of the present invention;

FIG. 8 is a flowchart illustrating a method for controlling a screen in a mobile terminal according to a fourth exemplary embodiment of the present invention;

FIG. 9 is a view illustrating a display screen of a mobile terminal displayed by a method for controlling a screen in a mobile terminal according to a fourth exemplary embodiment of the present invention;

FIG. 10 is a flowchart illustrating a method for controlling a screen in a mobile terminal according to a fifth embodiment of the present invention; and

FIG. 11 is a view illustrating a display screen of a mobile terminal displayed by a method for controlling a screen in a mobile terminal according to a fifth exemplary embodiment of the present invention.

### DETAILED DESCRIPTION

As used herein, the term “information screen” means a screen including at least one type of information, and may be any one of various screens displayed on a mobile terminal such as a list screen, a web page (browser screen), a photo album screen, or a background screen. A scrollable information screen is an information screen in which all regions may not be displayed simultaneously on one display screen. In this case, when the scrollable information screen is initially displayed, only a portion of all regions of the total displayable information available on the information screen is displayed on the display screen. In the case of a photo album, the entire photo album comprising a sequence of images is considered a scrollable information screen.

As used herein, the term “display screen” means a screen displayed on a display unit of a mobile terminal. That is, the ‘display screen’ means a current display state displayed on the display unit of the mobile terminal. When only a portion of all regions on a scrollable information screen is displayed on the display screen, the display screen is a screen composed of that portion. In the case of a photo album, a display screen can display just a single photo of the information screen consisting of all photos within the photo album.

As used herein, the term “multi-touch sweep” means an operation in which a simultaneous touch contact is applied at a plurality of points, the touch contact at each at the plurality of points is swept across the screen in the same direction, and the touch contact is released. Stated another way, the multi-touch sweep means an operation in which a simultaneous touch is input at a plurality of points, and the touch is released after moving the touch locations across the screen in the same direction. Optionally, a multi-touch sweep can be recognized only if the sweep motion is sensed at a moving speed equal to or higher than a preset threshold speed. A start point of the multi-touch sweep may be an optional point of a current display screen.

As used herein, the term “single-touch sweep” means an operation in which a touch contact is applied at one point and the touch contact is swept across the screen to another location. Optionally, a a single-touch sweep can be recognized only if the sweep motion is sensed at a moving speed equal to or higher than a preset threshold speed. A start point of the single-touch sweep may be an optional point of a current display screen.

As used herein, the term “multi-touch double tap” means an operation in which a touch release is performed twice after a simultaneous touch is applied at a plurality of points. A multi-touch double tap can be considered recognized in some embodiments only after a second multi-touch tap is sensed within a preset time after a first multi-touch tap. An input point of the multi-touch double tap may be an optional point of a current display screen.

As used herein, the term “panning” means an operation that moves a displayed portion of a zoomed-in image so as to display another zoomed-in portion of the same image.

The word “scroll” is used interchangeably herein with the phrase “move and display” when referring to a change in a display screen to a display of an earlier or later part of a scrollable information screen. In either case, the visual change in the display screen can be designed to give the appearance as though the display itself is moving. Alternatively, in some circumstances, the visual display change can be designed to appear as an instantaneous change to a different portion of the information screen.

The term “touch input” is used herein to refer to an action by a user to make touch contact with a portion of the display screen. A touch input is made in order to request/command an action such as to initiate a scroll operation. A touch input also refers to an electronic signal generated by the device upon sensing the touch contact.

While the present disclosure illustrates a mobile terminal by way of example, the present invention is not limited thereto. The present invention is applicable to various other devices that include a touch screen, such as a touch screen digital camera.

A mobile terminal according to an embodiment of the present invention is a terminal including a touch screen. The mobile terminal can be configured by an information communication device and a multimedia device such as a Portable Multimedia Player (PMP), a Personal Digital Assistant (PDA), a Smart Phone, or an MP3 player.

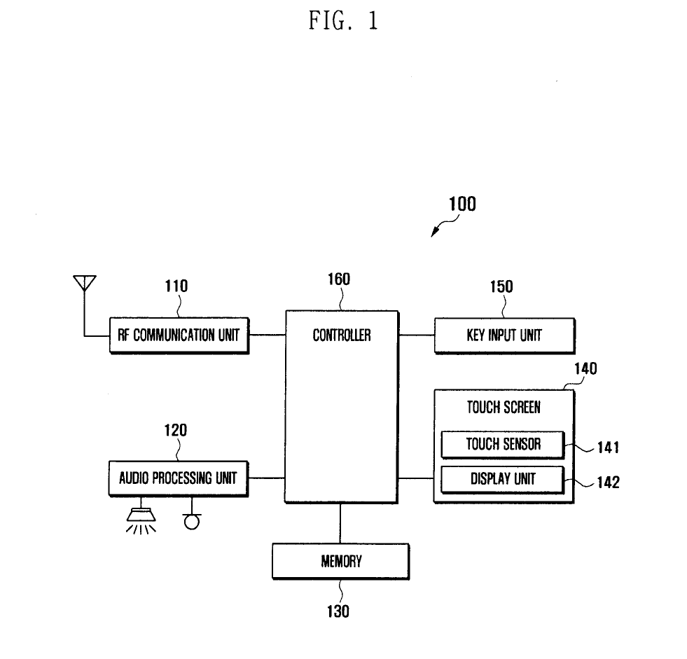

FIG. 1 is a block diagram illustrating a configuration of a mobile terminal 100 according to an exemplary embodiment of the present invention. The mobile terminal includes a radio frequency (RF) communication unit 110, an audio processing unit 120, a memory 130, a touch screen 140, a key input unit 150, and a controller 160.

The RF communication unit 110 performs transmitting and receiving functions of corresponding data for RF communication. The RF communication unit 110 may include a transmitter (not shown) up-converting a frequency of a transmitted signal and amplifying the signal, a receiver (not shown) low-noise-amplifying a received signal and down-converting the signal. Further, the RF communication unit 110 receives data through an RF channel and outputs the received data to the controller 160. The RF communication unit 110 may transmit data output from the controller 160 through the RF channel.

The audio processing unit 120 may be configured by a CODEC. The CODEC may include a data CODEC processing packet data and an audio CODEC processing an audio signal. The audio processing unit 120 converts a digital audio signal into an analog audio signal using the audio CODEC, and plays the analog audio signal using a speaker. The audio processing unit 120 converts an analog audio signal input from a microphone into a digital audio signal using the audio CODEC.

The memory 130 stores programs and data necessary for an operation of the mobile terminal 100. The memory 130 may be divided into a program area and a data area. The program area may store a program controlling an overall operation of the mobile terminal 100, an operating system (OS) booting the mobile terminal 100, an application program necessary for playback of multimedia contents, or other option functions of the mobile terminal such as a camera function, a sound playing function, or an image or moving image playing function. The data area stores data created according to use of the mobile terminal 100, for example, images, moving images, phone-books, and audio data.

The touch screen 140 includes a touch sensor 141 and a display unit 142. The touch sensor 141 senses touch input of a user. The touch sensor may be configured by a touch sensor such as a capacitive type, a resistive overlay type, an infrared beam type or a pressure sensor. Besides the foregoing sensors, various types of sensor devices capable of sensing contact or pressure of an object may be configured as the touch sensor 141 of the present invention. The touch sensor 141 of the present invention is preferably configured by a touch sensor capable of simultaneously touching at least two points. The touch sensor 141 senses touch input of a user, generates and transmits a sensing signal to the controller 160. The sensing signal contains coordinate data that a user input a touch. When the user inputs a touch location moving operation, i.e., a sweep operation along the screen surface, the touch sensor 141 generates and transmits a sensing signal including coordinate data of a sweep path to the controller 160. In some embodiments of the present invention, a sweep operation can be distinguished from a “drag” operation by the sweep speed. That is, if the sensed sweeping motion has a moving speed higher than a preset threshold speed, it can be sensed as a sweep; if the sweep speed is lower than the threshold, it can be sensed as a drag. A drag is an operation in which a selected icon is moved to another location on the display screen while other images on the screen remain fixed. A sweep operation, by contrast, gives the user the impression that the entire display is moving.

The display unit 142 may be configured by a Liquid Crystal Display (LCD), an Organic Light Emitting Diode (OLED), or an Active Matrix Organic Light Emitting Diode (AMOLED). The display unit 142 visibly provides a menu, input data, function setting information, and various other information of the mobile terminal 100 to a user. The display unit 142 performs a function outputting a booting screen, an idle screen, a menu screen, a call screen, and other application screens of the mobile terminal 100.

The key input unit 150 receives a key operation of a user for controlling the mobile terminal 100, and generates and transmits an input signal to the controller 160. The key input unit 150 may be configured by a button type key pad including numeral keys and arrow keys. The key input unit 150 may be configured by a predetermined function key provided at one side of the mobile terminal 100. In some embodiments of the present invention, the key input unit 150 may be omitted in a mobile terminal capable of performing various operations by only the touch screen 140.

The controller 160 controls an overall operation with respect to respective structural elements of the mobile terminal 100. The controller 160 of the present invention controls the display unit 142 to display a scrollable information screen. The controller 160 controls the touch sensor 141 to determine whether a multi-touch sweep is received. If the multi-touch sweep is received, the controller 160 controls the display unit 142 to move and display a current display screen to an earlier or later portion of the overall information screen to which it belongs, according to a direction of the multi-touch sweep. For example, if sensing the multi-touch sweep of a downward direction through the touch sensor 141, the controller 160 controls the display unit 142 to move and display a currently displayed image portion towards a lower end of the information screen. If sensing the multi-touch sweep of a upward direction through the touch sensor 141, the controller 160 can control the display unit 142 to move and display the currently displayed image portion towards an upper end of the information screen. If sensing input of a single-touch sweep through the touch sensor 141, the controller 160 checks a moving direction, a moving distance, and moving speed of the sweep, and controls the display unit 142 to scroll and display an information screen according to the checked moving direction, moving distance, and moving speed.

The controller 160 can be further configured (or alternatively configured) to recognize and respond to multi-touch double tap operations in accordance with embodiments of the invention. That is, scroll operations can be implemented in response to sensing a multi-touch double tap. In this case, when recognizing a multi-touch double tap through the touch sensor 141, the controller 160 can determine an input location of the multi-touch tap, and control the display unit 142 to scroll to an earlier or later part of an overall information menu or screen sequence based on the determined location. For example, when a current display screen is divided into “n” equal parts displayed vertically and a touch input is sensed, the controller 160 may recognize which one of the n sections has been touched by the user. If recognizing that touch input at a first section through the touch sensor 141, the controller 142 controls an operation of moving and displaying the display screen to a start point of the information screen. If recognizing a touch input at an n-th section, the controller 160 can control the display unit 142 to move and display the display screen to an end part of the information screen.

The controller 160 according to an embodiment of the present invention controls the display unit 142 to display a scrollable information screen. If recognizing input of a multi-touch sweep through the touch sensor 141, the controller 160 may control the display unit 142 to scroll and display the information screen with speed S1. If recognizing input of a single-touch sweep through the touch sensor 141, the controller 160 may control the display unit 142 to scroll and display the information screen with speed S2. That is, the controller 160 scrolls the information screen with different speeds at the input time of the multi-touch sweep and the input time of the single-touch sweep. In this case, S2 may be a multiple of S2.

The controller 160 according to another embodiment of the present invention controls a display unit 142 to display a scrollable information screen. If recognizing input of a multi-touch sweep through the touch sensor 141, the controller 160 may measure a first distance between a start point of a touch and a release point of the touch, and a second distance from the start point of the touch to an end point of a current display screen in a sweep direction, measures a rate of the first distance and the second distance, and control the display unit 142 to display the touch to a point corresponding to the computed rate from the start point of the touch to an end part of the information screen. If recognizing input of a single-touch sweep through the touch sensor 141, the controller 160 may determine at least one of a moving direction, a moving distance, or moving speed of a sweep, and control the display unit 142 to scroll and display an information screen according to the determined moving direction, moving distance, or moving speed.

The controller 160 according to an embodiment of the present invention controls the display unit 142 to display a zoom-in image. If recognizing input of a multi-touch sweep through the touch sensor 141, the controller 160 may control the display unit 142 to switch and display the image to a previous or next image. If recognizing input of a single-touch sweep, the controller 160 may perform panning of a current displayed zoom-in image.

The foregoing exemplary embodiment has illustrated a configuration of a mobile terminal 100 for controlling a screen according to the present invention. Hereinafter, a method for controlling a screen in a mobile terminal 100 will be described in detail.

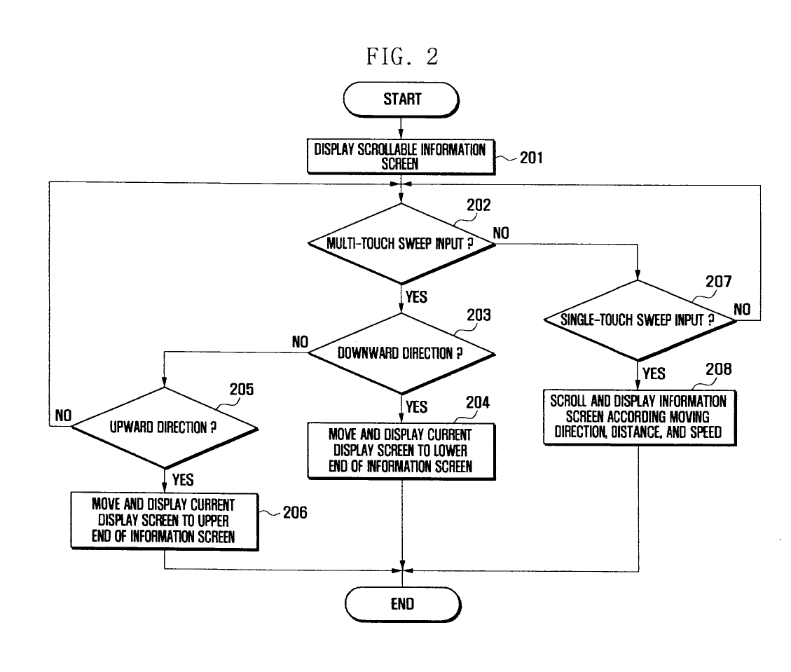

FIG. 2 is a flowchart illustrating a method for controlling a screen in a mobile terminal 100 according to a first embodiment of the present invention.

A controller 160 controls a display unit 142 to display a scrollable information screen (201). The scrollable information screen of the present invention is an information screen that all regions may not be displayed on one display screen. Upon first display, only a part of all regions on the information screens is displayed on the display screen. The scrollable information screen may include various screens displayable on the mobile terminal 100 such as an item list screen or a web browser screen. If a user inputs a touch for scroll, the controller 160 controls the display unit 142 to move and display an information screen. At this time, a part which is not displayed currently is generated to be displayed on a display screen. A user may confirm an entire information screen through scroll. In an embodiment of the present invention, a scroll bar guiding a scroll operation may be additionally displayed on a partial region of the scrollable information screen.

The controller 160 controls a touch sensor 141 to determine whether a multi-touch sweep is input (202). As mentioned above, a multi-touch sweep of the present invention means an operation in which a simultaneous touch is input at a plurality of points and a touch is released after moving a touch location of all the points in the same direction. The controller 160 determines whether a direction of a multi-touch sweep is a downward direction (203). If the direction of a multi-touch sweep is the downward direction, the controller 160 controls 142 to move and display a current display screen to a lower end of an information screen (204).

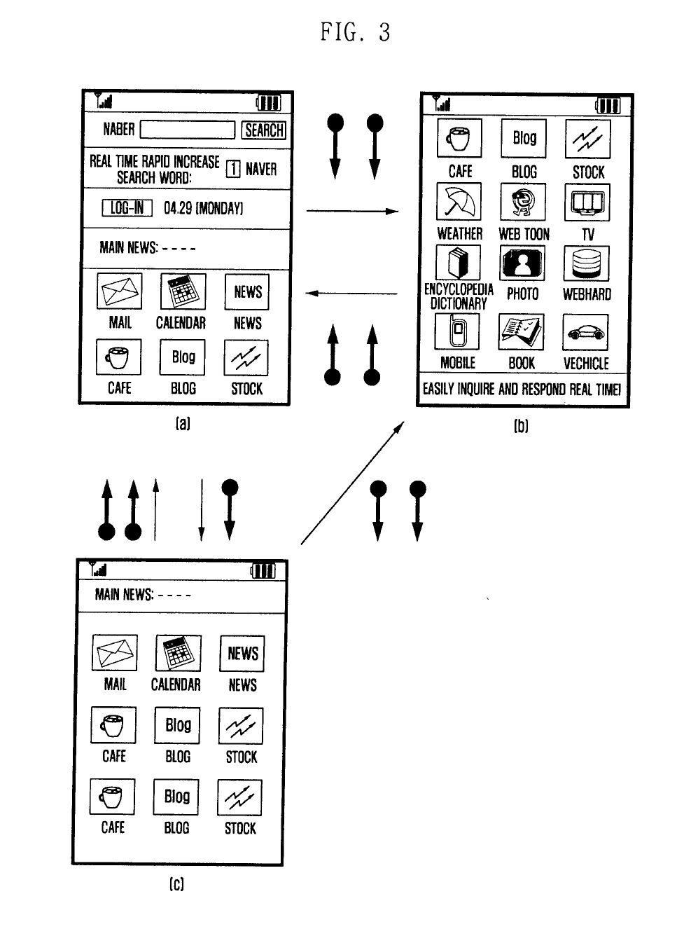

FIG. 3 is a view illustrating a display screen of a mobile terminal displayed by a method for controlling a screen in a mobile terminal according to a first embodiment of the present invention. A display screen[a] shows a web browser screen. Screen [a] shows only a partial region of one web page. If a user inputs a multi-touch sweep in a downward direction in an optional location of the current display screen, the screen is switched to a display screen [b], which shows a display moved to a lower end of the web page.

If a moving direction of the multi-touch sweep is not the downward direction at 203, the controller 160 determines whether the moving direction of the multi-touch sweep is a upward direction (205). When the moving direction of the multi-touch sweep is the upward direction, the controller 160 controls the display unit 142 to move and display a display screen to an upper end of the information screen (206).

If a user inputs a multi-touch sweep of the upward direction in a displayed state of the lower end of the information screen as shown in screen[b] of FIG. 3, the display screen is moved and displayed to an upper end of the information screen as shown in screen[a].

If the multi-touch sweep is not input through the touch sensor 141 at step 202, the controller 160 determines whether a single-touch sweep is input through the touch sensor 141 (207). The single-touch sweep of the present invention means an operation that a touch is input at one point and the touch is released after moving a touch location. In particular, it is preferred that the single-touch sweep of the present invention means an operation having touch location moving speed equal to or higher than preset threshold speed. A start point of the single-touch sweep may be an optional point of a current display screen.

If the single-touch sweep is input through the touch sensor 141 at step 207, the controller 160 checks a moving direction, a moving distance, and moving speed of the single-touch sweep, and controls the display unit 142 to scroll and display the information screen according the determined moving direction, moving distance, and moving speed (208).

With continued reference to FIG. 3, if a user inputs a single-touch sweep of a downward direction on display screen [a], the web page is scrolled and displayed as shown in display screen[c]. The controller 160 determines a moving direction, a moving distance, and moving speed of the single-touch sweep, and controls the display unit 142 to scroll and display the web browser screen according to the determined moving direction, a moving distance, and moving speed. If a user inputs a multi-touch sweep of an upward direction on display screen [c], a display screen is moved and displayed to an upper end of the information screen as shown by screen [c].

The above description of the first embodiment has illustrated that a display screen can be moved and displayed to an upper end or a lower end of the information screen according to a multi-touch sweep in a downward direction or an upward direction by way of example. However, the present invention is not limited thereto. Substantially the same explanation is applicable to a case where a display screen is moved to a left end or a right end of the information screen according to a multi-touch sweep of a left direction or a right direction. A particular application of the latter is for a photo album application, in which the entire photo album is considered the scrollable information screen.

Further, the description of the first embodiment has illustrated that a display screen is moved to a lower end of the information screen when a multi-touch sweep of a downward direction is input, and the display screen is moved to an upper end of the information screen when a multi-touch sweep of an upward direction is input. However, the present invention is not limited thereto. Substantially the same explanation is applicable to a case where a display screen is moved to an upper end of the information screen when a multi-touch sweep of a downward direction is input and a display screen is moved to a lower end of the information screen when a multi-touch sweep of an upward direction is input.

In the first exemplary embodiment, when a user inputs a single-touch sweep to scroll the information screen and then rapidly moves the information screen to an upper end or a lower end, the user may thereafter input a multi-touch sweep to rapidly move the display screen to the upper end or the lower end of the information screen.

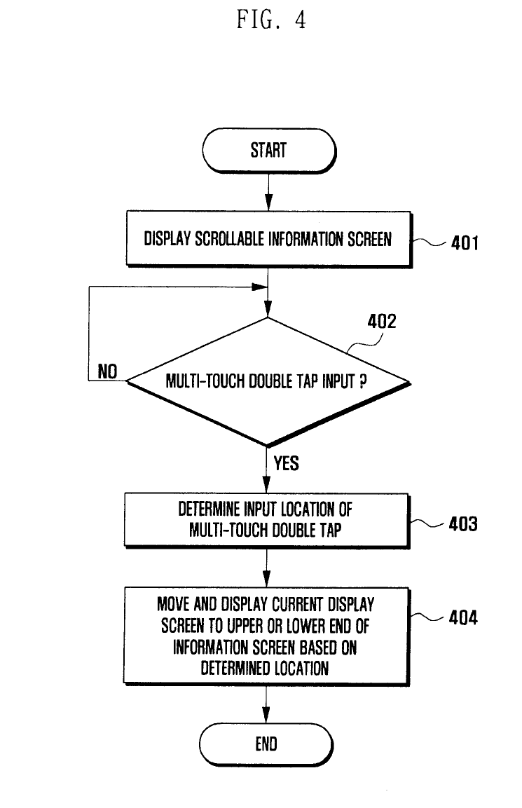

FIG. 4 is a flowchart illustrating a method for controlling a screen in a mobile terminal according to a second exemplary embodiment of the present invention.

A controller 160 controls a display unit 142 to display a scrollable information screen (401). Step 401 is identical to step 201 of FIG. 2, and in a similar manner to that described above in step 201 of FIG. 2, the same explanation is applicable to step 401.

The controller 160 controls a touch sensor 141 to determine whether a multi-touch double tap is input (402). As defined earlier, the multi-touch double tap in accordance with the present invention means an operation in which a touch release is performed twice after a simultaneous touch is input (i.e., touch contact is applied) at a plurality of points. An input point of the multi-touch double tap may be an optional point of a current display screen.

If the multi-touch double tap is input, the controller 160 determines an input location of the multi-touch double tap (403). The controller 160 controls the display unit 142 to move and display a current display screen to an upper end or a lower end of the information screen based on the determined location (404).

In an embodiment of the present invention, the display screen may be divided into n sections, where n is two or more. In this embodiment, for a vertically scrollable information screen, a user can apply a multi-touch double tap to an upper or lower region of the display screen in order to move (scroll) the display screen to a beginning part, or an end part, of the information screen. Similarly, for a horizontally scrollable information screen, a user can multi-touch double tap on a left-most region or a right-most region to instantly display the beginning or end portions of the information screen. To this end, the controller 160 may determine in which section a multi-touch tap is input. For example, when the display screen is divided into n equal sections up and down, the controller 160 may determine whether an input section of the multi-touch double tap is the n-th section from a top (i.e, whether the input section is the bottom section). At this time, if the multi-touch double tap is input at a first section of n sections (i.e., the top section), the controller 160 may control the display unit 142 to move and display the display screen to an upper end of the information screen. If the multi-touch double tap is input at an n-th section, the controller 160 may control the display unit 142 to move and display the display screen to a lower end of the information screen.

Meanwhile, when the display screen is divided into n equal sections left and right, the controller 160 may determine whether the input section of the multi-touch double tape is the n-th section from a left side. At this time, if the multi-touch double tap is input at a first section among n sections, the controller 160 may control the display unit 142 to move and display the display screen to a left end of the information screen. If the multi-touch double tap is input at an n-th section, the controller 160 controls the display unit 142 to move and display the display screen to a right end of the information screen.

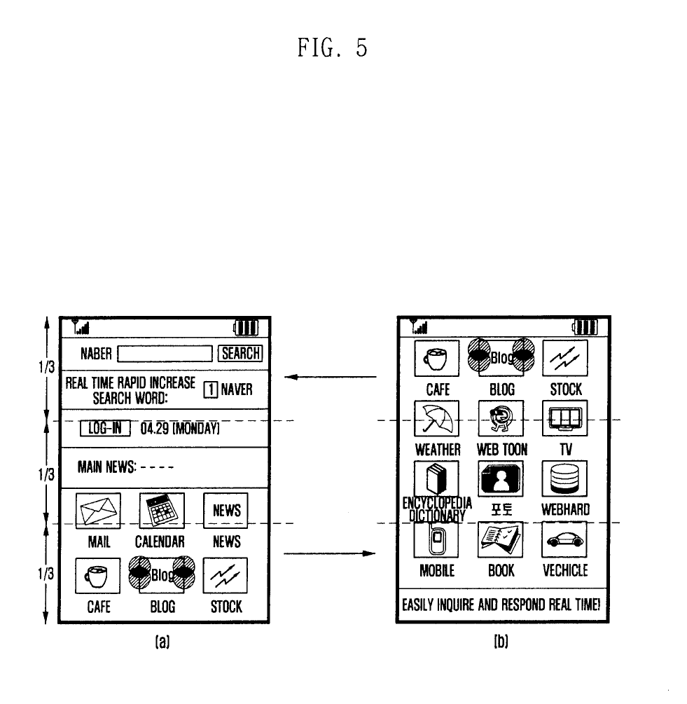

FIG. 5 is a view illustrating a display screen of a mobile terminal displayed by a method for controlling a screen in a mobile terminal 100 according to a second embodiment of the present invention. In FIG. 5, a display screen [a] shows a part of one web browser. The controller 160 divides the display screen into three sections up and down in this example. The controller 160 recognizes an upper ⅓ section, a center ⅓ section, and a lower ⅓ section as different regions. If the user inputs the multi-touch double tap at a third section among divided sections, namely, the lower ⅓ section, the controller 160 controls the display unit 142 to move and display the display screen to a lower end of the web browser screen. Screen [a] shows a symbol (dual overlapping shaded circles) signifying that a user inputs the multi-touch double tap at the lower ⅓ section. A display screen [b] illustrates that in response to the multi-touch double tap, the display is moved to a lower end of the web browser screen.

Further, as shown in screen[b], if a user inputs the multi-touch double tap at an upper ⅓ section in a displayed state of a lower end of the web browser, a display screen as shown in screen[a] is moved and displayed to an upper end of the web browser screen.

In the second exemplary embodiment, when a user wants to rapidly move the display screen to an upper or lower end of the information screen while scrolling the information screen after inputting a single-touch sweep, the user inputs the multi-touch double tap to rapidly move the display screen to the upper end or the lower end of the information screen.

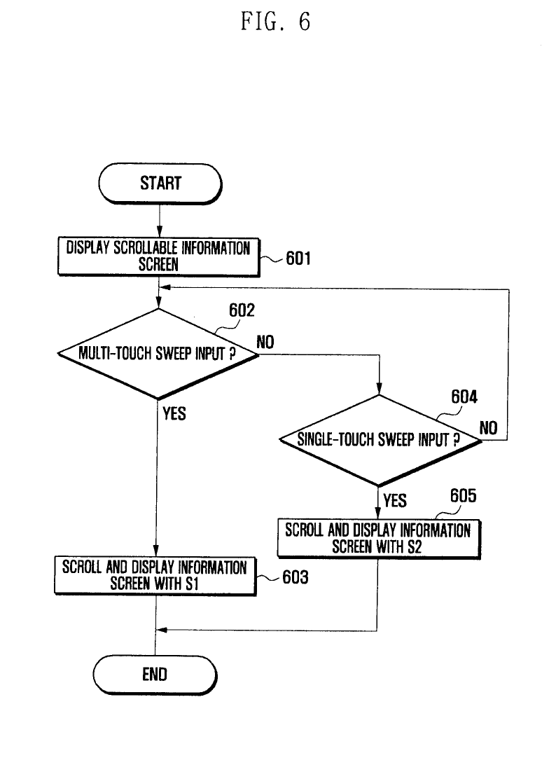

FIG. 6 is a flowchart illustrating a method for controlling a screen in a mobile terminal 100 according to a third embodiment of the present invention.

A controller 160 controls a display unit 142 to display a scrollable information screen (601). Step 601 is identical to step 201 of FIG. 2, and in a similar manner to that described above in step 201 of FIG. 2, the same explanation is applicable to step 601.

The controller 160 controls a touch sensor 141 to determine whether a multi-touch sweep is input (602). If the multi-touch sweep is input, the controller 160 controls the display unit 142 to scroll and display the information screen with speed S1 (603).

If the multi-touch sweep is not input at step 602, the controller 160 determines whether a single-touch sweep is input through the touch sensor 141 (604). If the single-touch sweep is input, the controller 160 controls the display unit 142 to scroll and display the information screen with speed S2 (605). In the present invention, it is preferred that S1 is greater than S2. S1 may be an n multiple of S2.

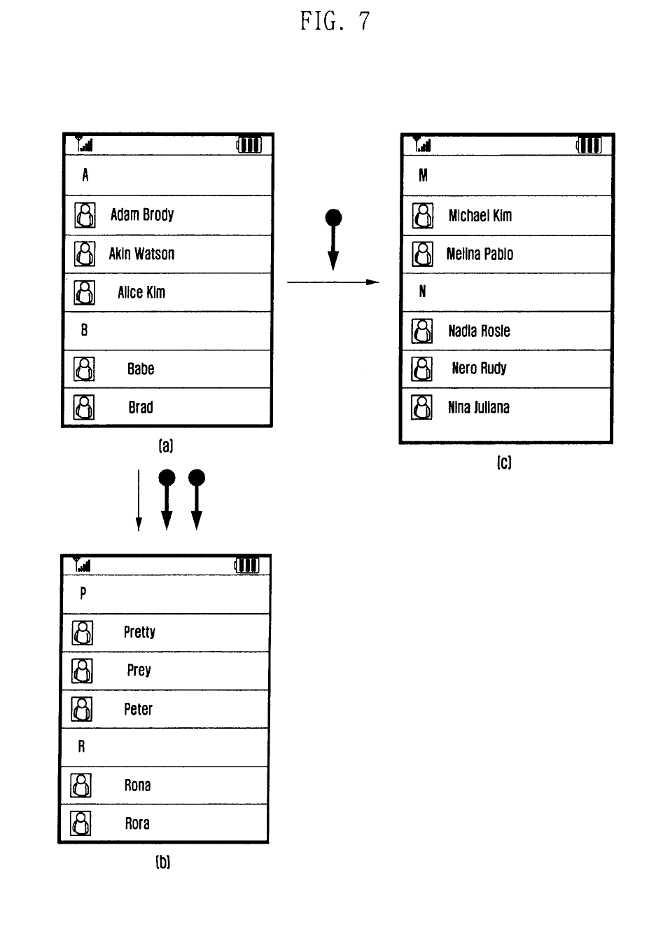

FIG. 7 is a view illustrating a display screen of a mobile terminal displayed by a method for controlling a screen in a mobile terminal according to a third embodiment of the present invention. A display screen[a] in FIG. 7 shows a phonebook screen. Display screen [a] shows a part of a list constituting the phonebook. A list classified by ‘A’ and ‘B’ categories is displayed on a current display screen, and a user may confirm a list of a next category through scroll.

A display screen [b] in FIG. 7 shows a display changed when a user inputs a multi-touch sweep of a downward direction on display screen [a]. A display screen [c] shows a display changed when a user input a single-touch sweep of a downward direction on the display screen [a]. In comparing screens [b] and [c], it is seen that screen [b] has been scrolled further than screen [c] with respect to screen [a]. That is, [c] shows a list classified by ‘M’ and ‘N’ categories, and [b] shows a list classified by ‘P’ and ‘R’ categories. This is because speed S1 corresponding to a multi-touch sweep is set to be greater than speed S2 corresponding to the single-touch sweep. For example, the speed S1 corresponding to a multi-touch sweep can be set on the order of double the speed S2 corresponding to the single-touch sweep.

In an embodiment of the present invention, speed corresponding to the single-touch sweep is S2 and speed S1 corresponding to the multiple-touch sweep is n×S2, and n may be set to the number of touched points. (Alternatively, S1 can be set to nk×S2 where k is a constant. Thus if k is set at less (more) than 1, S1 will be less (more) than twice as fast for a two point touch and less (more) than three times as fast for a three point touch.) In this embodiment, if recognizing input of a multi-touch sweep through a touch sensor 141, the controller 160 determines in how many points a touch is input, determines scroll speed according to the determined number of points, and controls the display unit 142 to scroll and display an information screen according to the determined scroll speed. For example, when the user inputs the multi-touch sweep using two fingers, the controller 160 may control the display unit 142 to scroll and display the information screen with a double of scroll speed at the input time of the single-touch sweep. When the user inputs the multi-touch sweep using three fingers, the controller 160 may control the display unit 142 to scroll and display the information screen with a triple of speed at the input time of the single-touch sweep.

When a user wants a rapid scroll while scrolling the information screen after inputting a single-touch sweep, the third embodiment inputs the multi-touch sweep to increase scroll speed.

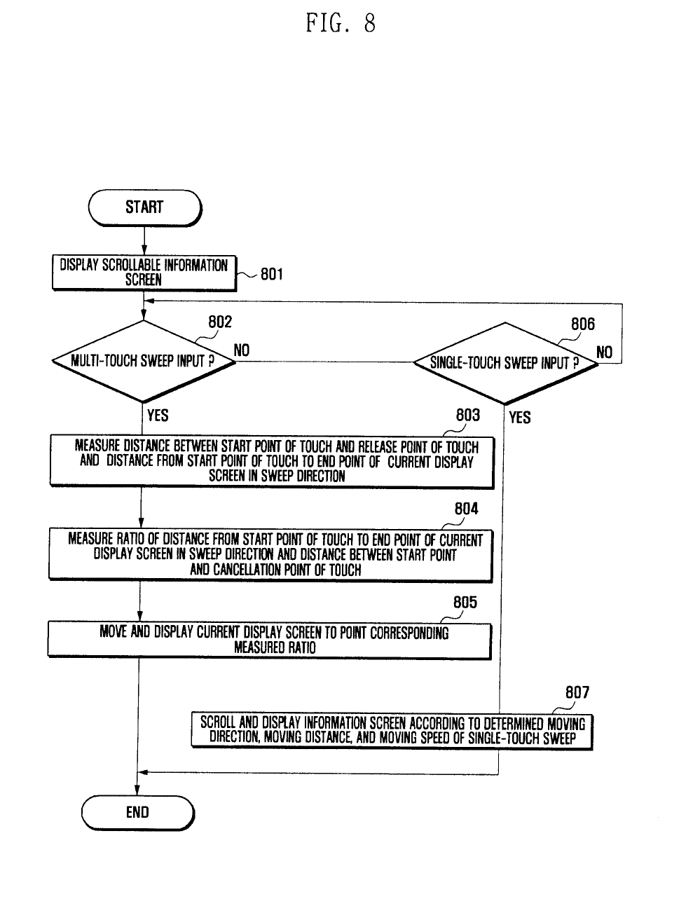

FIG. 8 is a flowchart illustrating a method for controlling a screen in a mobile terminal 100 according to a fourth embodiment of the present invention. In this embodiment, a controller 160 controls a display unit 142 to display a scrollable information screen (801). Step 801 is identical to step 201 of FIG. 2, and a description of step 801 is applied in the same manner as that of step 201.

The controller 160 controls a touch sensor 141 whether a multi-touch sweep is input (802). If the multi-touch sweep is input, the controller 160 measures a distance between a start point of a touch and a release point of the touch and a distance from the start point of the touch to an end point of a current display screen in a sweep direction (803).

In a case of a vertically scrollable information screen, the controller 160 may measure the vertical axis component of the distance separating the start and release points of the multi-touch sweep. This can be done by measuring the shortest distance between a parallel line passing through a start point of the multi-touch sweep and a parallel line passing through the end point thereof, thereby measuring a distance between the start point and the release point of the touch. When heights of two start points (or two release points) of the multi-touch sweep of the multi-touch sweep differ from each other, the controller 160 may compute and use an average of the two points. This can be done by measuring the shortest distance between parallel lines passing through the respective points, and recognize a minimum value or a maximum value among the measured distances as the distance between the start point and the release point of the touch.

Further, the controller 160 may measure the shortest distance between a parallel line passing through a start point of the multi-touch sweep and a parallel line passing through a lower end of a current display screen, thereby measuring a distance from the start point of the touch to an end point of a current display screen in a sweep direction. When heights of two start points of the multi-touch sweep differ from each other, the controller 160 may measure the shortest distance between parallel lines passing through the two points and a parallel line passing through a lower end of the current display screen, and recognize a minimum value or a maximum value among the measured distances as the distance from the start point of the touch to an end point of the current display screen in a sweep direction.

In a case of a scrollable information screen left and right, the controller 160 may measure the shortest distance between a vertical line passing through a start point of the multi-touch sweep and a vertical line passing through the end point, thereby measuring the distance between the start point and the release point of the touch. Further, the controller 160 may measure the shortest distance between the vertical line passing through a start point of the multi-touch sweep and a vertical line passing through a right end of a current display screen, thereby measuring a distance from the start point of the touch to an end point of the current display screen in a sweep direction.

The controller 160 measures a ratio of the distance from the start point of the touch to an end point of the current display screen in a sweep direction and the distance between the start point and the cancellation point of the touch (804). That is, the controller 160 measures a percentage of a distance from a start point to a cancellation point of a touch in a distance from the start point of the touch to an end part of a current display screen in a sweep direction.

Next, the controller 160 controls the display unit 142 to move and display the current display screen to a point corresponding to the measured ratio at step 804 from the start point of the touch to the end point of the information screen (805). For example, when a percentage of a distance from a start point of a touch to a cancelation point of the touch to a distance from the start point of the touch to an end part of the current display screen in a sweep direction is 40%, the controller 160 controls the display unit 142 to move and display the current display screen to a point of 40% from the start point of the touch to an end part of the information screen. For example, the controller 160 controls the display unit 142 to move and display the current display screen to a point corresponding to upper 40% from the start point of the touch to the end point of the information screen.

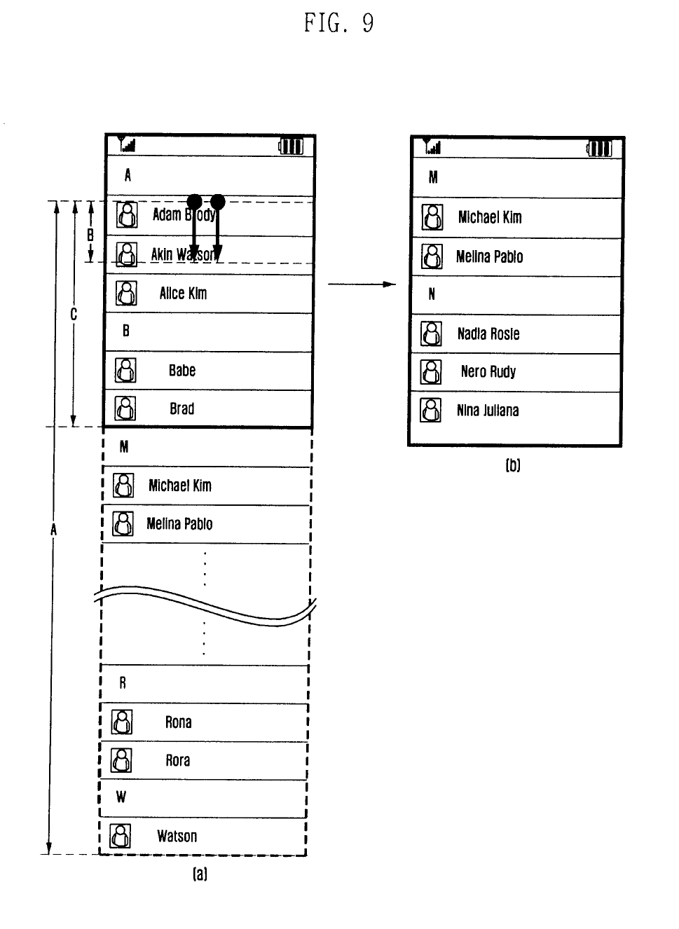

FIG. 9 is a view illustrating a display screen of a mobile terminal displayed by a method for controlling a screen in a mobile terminal 100 according to a fourth embodiment of the present invention. A display screen designated as [a] shows a part of a list constituting the phonebook. A distance ‘A’ is a distance from a start point of a touch to an end part of an information screen (phonebook screen), ‘B’ is a distance from the start point of a touch to a cancellation point of the touch, and ‘C’ is a distance from the start point of a touch to an end part of a current display screen. Screen [a] shows a form of a multi-touch sweep input by a user, and display screen [b] is a display screen changed after input of the multi-touch sweep by the user. After computing B/C, the controller 160 controls the display unit 142 to move and display the current display screen to a point corresponding to B/C among an entire information screen A. Screen [b] shows a form of the current display screen moved to a B/C point of the entire information screen (phonebook screen) A. Screen [b] shows a list part including

‘Micheal Kim’ and ‘Melina Pable’ corresponding to the B/C point among an entire phone book screen A.

In an embodiment of the present invention, the controller 160 may measure only a distance between a start point and an end point of a touch (803), measure a ratio of a distance between upper and lower ends of a display screen and the measured distance between a start point and an end point of a touch (804), and control the display unit 142 to move and display a point corresponding to the measured ration between the start point and the end point of the touch.

If the multi-touch sweep is input through the touch sensor 141 at step 802, the controller 160 determines whether a single-touch sweep is input (806). If the single-touch sweep is input, the controller 160 checks a moving direction, a moving distance, and moving speed of the single-touch sweep, and controls the display unit 142 to scroll and display an information screen according to the determined moving direction, moving distance, and moving speed thereof (807).

When a user wants to jump movement to a certain point of a predetermined ratio among an entire information screen while scrolling an information screen after inputting a single-touch sweep, the fourth embodiment may input a multi-touch sweep having a predetermined distance to directly move the screen to a desired point.

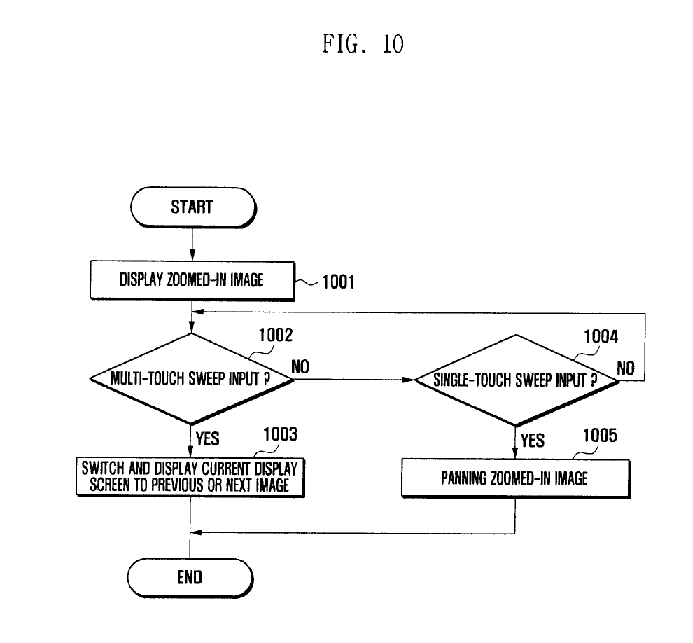

FIG. 10 is a flowchart illustrating a method for controlling a screen in a mobile terminal 100 according to a fifth embodiment of the present invention.

A controller 160 controls a display unit 142 to display a zoom-in image (1001). Concretely, the controller 160 executes an image view application according to user input, and then controls the display unit 142 to display an image specified by a user among stored images. If sensing a single-touch sweep of a user through a touch sensor 141, the controller 160 controls a display unit 142 to move and display the image to a previous image or a next image.

If sensing a multi-touch drag of a different direction through the touch sensor 141, the controller 160 controls the display unit 142 to zoom in and display a current displayed image. In the present invention, a multi-touch drag is an operation moving a touch location after a user simultaneously input a touch on two points, and multi-touch drags of different directions are operations having different moving directions at two touch input points. In an embodiment of the present invention, the controller 160 may control the display unit 142 to display Graphic User Interface (GUI) for image zoom in/out operations. When receiving a zoom in command from the user through the GUI, the controller 160 may control the display unit 142 to zoom in and display the current displayed image.

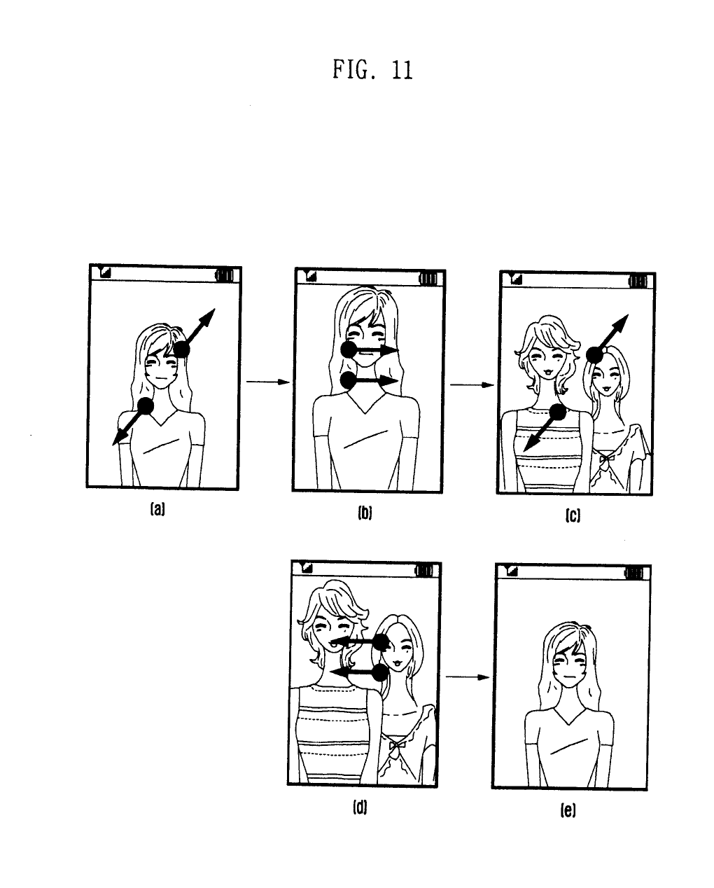

FIG. 11 is a view illustrating a display screen of a mobile terminal displayed by a method for controlling a screen in a mobile terminal 100 according to a fifth embodiment of the present invention. A display screen [a] illustrates an original size photo. The arrows shown pointing in opposite directions illustrates an exemplary (and conventional) multi-touch operation to zoom in on the image, resulting in the enlarged image of display screen [b]. The controller 160 determines whether a multi-touch sweep is input through a touch sensor 141 (1002). If the multi-touch sweep is input, the controller 160 controls the display unit 142 to switch and display the current display screen to a previous or next image (1003).

If the multi-touch sweep is not input at step 1002, the controller 160 determines whether a single-touch sweep is input through the touch sensor 142 (1004). If the single-touch sweep is input, the controller 160 controls the display unit 142 to perform panning of the current displayed zoomed-in image (1005). In the present invention, the panning is an operation that moves around regions of a displayed zoomed-in image or original sized image to change a displayed part of a current display screen.

That is, the controller 160 handles an input case of the multi-touch sweep and an input case of the single-touch sweep differently. When inputting the multi-touch sweep, it is switched to a next image or a previous image. When inputting the single-touch sweep, the controller 160 performs panning of a current displayed image.

In the fifth embodiment, when executing an image view application (e.g photo album application), because a user may switch an image to a subsequent image or a previous image in a sequence by only the multi-touch sweep in a zoomed in state of the image, it is unnecessary to take the additional step of restoring the zoomed-in image to its original size, as in conventional devices. Thus, when viewing an image in the zoomed-in state, the time to scroll to another image is reduced, thereby facilitating use and enhancing the user experience.

A mobile terminal or other electronic device in accordance with the invention can be configured to function with two or more of the above described first through fifth embodiments. Alternatively, it can be configured with only one of the first through fifth exemplary embodiments.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method for controlling a screen in a mobile terminal, the method comprising:
displaying a scrollable information screen;
sensing touch input at two or more points simultaneously on the information screen; and
scrolling the information screen in response to at least the sensing of the touch input, at a faster scroll rate than a scroll rate associated with a single point touch input.

2. The method of claim 1, wherein sensing touch input comprises sensing input of a touch location moving operation to the same direction after touching the at least two points.

3. The method of claim 2, wherein scrolling the information screen comprises:
scrolling a current display screen to a lower end of the information screen when a touch location moving operation to a downward direction is input; and
scrolling a current display screen to an upper end of the information screen when the touch location moving operation to a upward direction is input.

4. The method of claim 3, further comprising scrolling and displaying the information screen based on at least one of a moving direction, moving speed, or a moving distance when sensing input of a touch location moving operation after touching one point.

5. The method of claim 1, wherein sensing touch input comprises:
sensing input of a simultaneous tap to at least two points plural times; and
determining an input location of the tap, and
scrolling the information screen comprises scrolling a current display screen to a start part or an end part of the information screen according to the input location of the tap.

6. The method of claim 5, wherein determining an input location of the tap comprises determining whether the input location of the tap is an upper or lower region of a vertically scrollable information screen.

7. The method of claim 6, wherein scrolling the information screen comprises:
scrolling a current display screen to the start part of the information screen when the input location of the tap is the upper region, and
scrolling the current display screen to the end part of the information screen when the input location of the tap is the lower region.

8. The method of claim 2, wherein scrolling the information screen comprises scrolling the information screen with speed corresponding to the number of touch input points.

9. The method of claim 2, wherein scrolling the information screen comprises scrolling and displaying the information screen with preset multiple of scroll speed set corresponding to a touch location moving operation associated with a single point touch.

10. The method of claim 2, wherein scrolling the information screen comprises
measuring a first distance between a start point and a release point of a touch and a second distance from the start point of the touch to an end part of a current display screen in a moving direction of the touch;
measuring a ratio of the first distance and the second distance; and
scrolling a current display screen to a point corresponding to the measured rate from the start point of the touch to the end part of the information screen.

11. The method of claim 10, further comprising scrolling and displaying the information screen based on at least one of a moving direction, moving speed, or a moving distance when sensing input of a touch location moving operation associated with a single touch input.

12. A method for controlling a screen in a mobile terminal, the method comprising:
displaying a zoomed-in image in a current display screen; and
switching and displaying the current display screen to a previous or subsequent image according to a moving direction of a touch when a touch location moving operation to the same direction is input after simultaneous touch to at least two points, and panning the zoomed-in image according the moving direction of a single point touch.

13. A mobile terminal comprising:
a display unit for displaying a scrollable information screen;
a touch sensor sensing touch input to at least two points; and
a controller controlling the display unit to move a current display screen to a certain region among entire regions of the information screen or scroll the information screen with speed corresponding to the number of touch input points.

14. The mobile terminal of claim 13, wherein the controller controls the display unit to move and display a current display screen to a start part or an end part of the information screen according to a direction of the touch location moving operation when input of a touch location moving operation to the same direction is sensed after performing simultaneous touch to at least two points through the touch sensor.

15. The mobile terminal of claim 13, wherein the controller controls the display unit to scroll and display the information screen with a preset multiple of scroll speed set corresponding to a touch location moving operation after touching one point when input of a touch location moving operation to the same direction is sensed after performing simultaneous touch to at least two points through the touch sensor.

16. The mobile terminal of claim 13, wherein the controller measures a first distance between a start point and a release point of a touch and a second distance from the start point of the touch to an end part of a current display screen in a moving direction of the touch when input of a touch location moving operation to the same direction is sensed after performing simultaneous touch to at least two points through the touch sensor; measures a ratio of the first distance and the second distance; and moves and displays a current display screen to a point corresponding to the measured rate from the start point of the touch to the end part of the information screen.

17. The mobile terminal of claim 13, wherein the controller determines an input location of the tap when input of a simultaneous tap to at least two points plural times is sensed; and controls the display unit to move and display a current display screen to a start part or an end part of the information screen according to the input location of the tap.

18. The mobile terminal of claim 13, wherein the controller controls the display unit to switch and display the current display screen to a previous or next image according to the touch moving direction when a touch location moving operation to the same direction is input after simultaneous touch to at least two points, and
controls the display unit to move and display the zoom-in image according to a touch moving direction when a touch location moving operation is sensed after touching one point through the touch sensor.

19. A method for controlling a screen in a mobile terminal, the method comprising:
displaying a display screen that is a portion of a scrollable information screen;
sensing at least one of a multi-touch sweep and a multi-touch double tap input; and
scrolling the display screen, responsive to at least said sensing, in a manner that is different than a scroll operation responsive to only a single point touch input.
